(19) United States
(12) Patent Application Publication
(10) Pub. No.: US 2003/0211450 A1
(43) Pub. Date: Nov. 13, 2003

(54) Method and apparatus for self-paced integrated procedure training using a real-time, full-scope simulation

(75) Inventors: Kamilia Sofia, Dollard-des-Ormeaux (CA); Michele Asmar, Dollard-des-Ormeaux (CA); Luc Ethier, Laval (CA); Jean Genest, Dollard-des-Ormeaux (CA)

Correspondence Address: OGILVY RENAULT, 1981 MCGILL COLLEGE AVENUE, SUITE 1600, MONTREAL, QC, H3A2Y3, CA

(73) Assignee: CAE Inc., Saint Laurent (CA)

(21) Appl. No.: 10/139,216

(22) Filed: May 7, 2002

(51) Int. Cl. G09B 3/00

(52) U.S. Cl. 434/350

(57) ABSTRACT

A self-paced simulation-based integrated procedure trainer using system and procedure courseware that operates on complex system full-scope simulation increases a quality of training by its inherent fidelity. The system reduces a requirement for classroom training, as well as a requirement for instructor supervised training devices. A validation filter function ensures that inexperienced students are not able to destabilize the simulation by incorrect inputs during an integrated procedure practice. A learning management system relates an appropriate sequence of training events and appropriate courses to follow in order to obtain a related operator or maintenance rating that a student desires to obtain.

### CROSS-REFERENCE TO RELATED APPLICATIONS

This is the first application filed for the present invention.

### MICROFICHE APPENDIX

Not applicable.

### TECHNICAL FIELD

This invention relates in general to the training of operator and maintenance personnel and, in particular, to a method and apparatus for self-paced integrated procedure training on real-time, full-scope simulation in order to enhance student training and reduce training cost.

### BACKGROUND OF THE INVENTION

The training of operators and maintenance personnel for complex systems, such as commercial jet airliners, nuclear power plants, and the like, represents a major overhead component of affected business budgets. Extensive training is required to qualify operators and maintenance personnel for respective procedures on each platform. A significant part of the training is dedicated to learning systems and procedures for operating and maintaining the complex system. Furthermore, industry forecasters are predicting that the training burden will likely significantly increase in the foreseeable future. In the case of aircraft pilots, there are several reasons for this prediction. Not only are many pilots and mechanics currently in the work force scheduled to retire over the next few years, there has also been a reduction in the number of military pilots that migrate to the commercial airline system. The demand for training is further compounded by the fact that even experienced pilots require extensive system and procedure training before they can fly an aircraft with which they have no prior experience. Aircraft fleets are also generally enlarging and air traffic is expected to more than double over the next 20 years.

In addition to a growing demand for training and service, most industries and government institutions are under pressure to lower costs and operate more efficiently. Consequently, there is a demand for more effective training at lower cost.

It has been generally accepted in many industries that training costs can be reduced by introducing computer-based training (CBT), especially if the computer-based training can be made available to geographically dispersed trainees.

For example, U.S. Pat. No. 6,162,060, which issued on Dec. 19, 2000 to Richard et al., teaches a network system for computer-aided instruction that includes a main computer with a repository for storing courseware, a network of servers connected to the main computer and a number of local area networks (LANs) . Each of the LANs are connected to a server, and each LAN includes a number of interconnected workstations. A distributed delivery system is responsive to a student's request for a course, and operable to search the network for a server where the requested course resides. The delivery system is also operable to retrieve the course from the repository and present the course to the student. An authoring system is likewise provided to facilitate the creation of courseware

Although computer-based training is well known in the air transportation industry, computer-based training still forms a minor part of the system and procedure training process, because developing courseware is tedious, and a method for achieving integrated system and procedure training has, to date, not been available. Integrated system and procedure training is known in simpler systems, such as telecommunications networks, as described in U.S. Pat. No. 6,371,765, which issued on Apr. 16, 2002 to Wall et al. Wall et al. describe an interactive computer-based training (ICBT) system and method operable over a computer network for training users. The ICBT system is provided with a state-machine-based hardware simulator for emulating various hardware states associated with a piece of equipment on which the users are to receive interactive training. A software simulator provided as a command interface engine is coupled to the hardware simulator. The software simulator permits the users to interactively interrogate the emulated piece of equipment for its software functionality. One or more independently selectable learning modules are provided as part of the ICBT system. Each learning module includes one or more lesson plans related to the hardware and software functionality of the emulated piece of equipment. The learning modules are inter-dependently associated with the hardware and software simulators. A user interface is provided for selecting one or more learning modules and for providing inputs from the users to the hardware and software simulators of the emulated piece of equipment so as to modify its configuration. The users can select any lesson plan or execute a portion of an ICBT session at any point, without having to follow a sequential procedure.

While the advances in the delivery, authoring and management of courseware over computer networks and their association with simple system emulators have facilitated and accelerated learning in the computer and telecommunications industries, the training of complex system operators and maintenance personnel remains a substantially instructor-based system that requires a large number of highly qualified professionals and expensive equipment such as training devices and full-scope simulators. The dependence on highly qualified professional instructors not only throttles the system, it also contributes significantly to the cost. This is particularly true in the case where instructors are required to teach systems and procedures using equipment that is expensive to purchase and maintain.

There therefore remains a need for an approach to the training of complex system operators and maintenance personnel that reduces costs while increasing training capacity and training quality of the current systems.

### SUMMARY OF THE INVENTION

It is therefore an object of the invention to provide a method and apparatus for self-paced integrated system training and self-paced integrated procedure training on real-time, full-scope simulation that reduces the cost of providing accepted training courses while reserving highly qualified instructors for training on training devices and full-scope simulators where the instructor's time is most profitably focused.

As used in this document a “full-scope simulation” means a simulation that integrates models of multiple (different) subsystems of a complex real system in order to produce responses that are substantially identical to the complex real system, and an “integrated procedure” is any procedure that requires interaction with multiple subsystems of the complex real system.

The invention therefore provides a method for self-paced integrated procedure training using courseware on real-time, full-scope simulation. In accordance with the method, self-paced courseware is provided to students to permit the students to learn systems and integrated procedures related to a qualification that the student desires to obtain. The courseware is associated with interactive graphical representations of portions of the simulated complex system that the student interacts with in order to learn the systems and integrated procedures. The student's responses generate inputs that are passed over a link between the interactive graphical representations and the real-time, full-scope simulation to provide input data to the full-scope simulation. Feedback of a condition of the real-time, full-scope simulation is provided to the student by dynamically updating the graphical representations of the parts of the simulated complex system with which the student interacts.

Consequently, the self-paced systems and integrated procedures are taught on a real-time, full-scope simulation to provide the student with an integrated training experience that is virtually identical to working with a fully functional, complex real system. The mental models of the complex real systems are therefore quickly developed, and student learning progresses at a faster rate than is possible with existing classroom and computer-based training systems in which a non-integrated approach is taken to the problem of system and procedure training.

The invention further provides an apparatus for self-paced integrated system and integrated procedure training. The apparatus comprises a computer system program with self-paced courseware programs adapted to permit a student to learn systems and procedures related to a qualification that the student desires to obtain. The apparatus further provides a link between the computer system program and a real-time, full-scope simulation to permit a condition of the real-time, full-scope simulation to be changed in response to inputs to the computer system program by the student, and to further permit the condition of the simulation to be communicated to the student through dynamic updates of graphical representations of the simulated complex system.

The apparatus may be local or distributed and training may be provided in the classroom, over a local area network, over a wide area network, or over the Internet. For cases requiring un-tethered portability, the link can be eliminated and a single computer system can be used to host the courseware, the graphical representations and the real-time, full-scope simulation. Alternatively, for cases where the application requires distribution on a network or Internet, the computer system program resides on the client side while the simulation resides on the server side.

### BRIEF DESCRIPTION OF THE DRAWINGS

Further features and advantages of the present invention will become apparent from the following detailed description, taken in combination with the appended drawings, in which:

FIG. 1a is a schematic diagram of a prior art method of training flight crew;

FIG. 1b is a schematic diagram of a method of training flight crew in accordance with the invention;

FIG. 2 is a schematic block diagram of self-paced training using system and procedure courseware that runs on full-scope simulation, in accordance with the invention;

FIG. 3 is a schematic block diagram of a system for providing self-paced training system and procedure courseware running on full-scope simulation;

FIG. 4 is a flow chart representing a simplified overview of the self-paced training procedure in accordance with the invention;

FIG. 5 is a schematic diagram of a computer system used by a student to display courseware in accordance with the invention; and

FIG. 6 is a schematic diagram of a three-dimensional training station that can be used as a display device for displaying courseware in accordance with the invention.

It will be noted that throughout the appended drawings, like features are identified by like reference numerals.

### DETAILED DESCRIPTION OF THE PREFERRED EMBODIMENT

The invention provides a method and apparatus for self-paced integrated system and procedure training on real-time, full-scope simulation. The self-paced integrated procedure training permits a student to learn complicated systems and develop mental models of complex integrated procedures, which constitute a significant portion of operator and maintenance personnel training. The system reduces reliance on highly skilled instructors, and permits a self-paced approach to learning that enables students to learn systems and procedures using interactive graphical displays of selected parts of the aircraft. Because the training is performed over a fully simulated aircraft, filters are included to prevent destabilizing input from the students during basic training modes of the courseware.

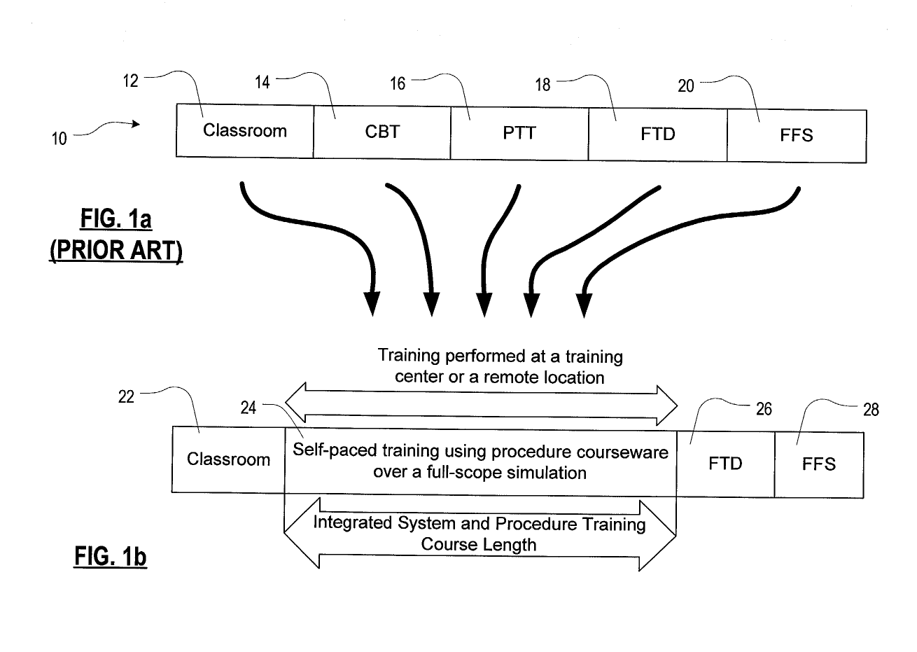

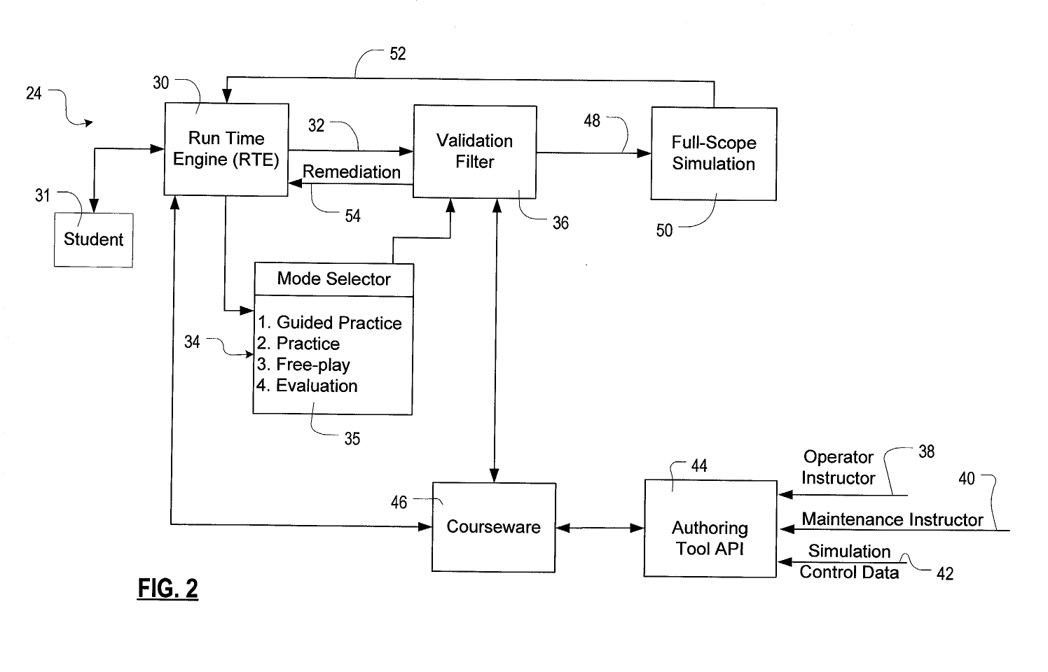

By way of example, FIG. 1a is a schematic diagram of a prior art training method 10 for aircraft flight crew personnel in accordance with methods that are well known in the art. A similar time line applies to many training programs for operators of complex systems. The training involves a progression of different training components and is subject to regulatory bodies and the companies that invest in this type of training. Typically training can begin with a classroom component 12 in which students are familiarized with an aircraft and the basic aircraft systems. A typical classroom training program presents the aircraft as a series of air transport authority (ATA) chapters, such as electrical system, hydraulic system, etc. The classroom training component 12 can be followed by a computer-based training (CBT) component 14 in which the student is exposed in more detail to aircraft systems and procedures. The computer-based training component includes courseware modules that introduce systems in more detail and lay the foundations for procedure training. This unintegrated approach fails to teach the interrelations of various aircraft systems.

Following the CBT component 14, the student can be provided with a part task training (PTT) component 16, which concentrates on partial systems to give the student a more in-depth understanding of the aircraft systems and related procedures. This can be followed by training on a flight training device (FTD) 18, which provides a replica of the aircraft cockpit with full scope simulation in order to thoroughly acquaint the students (a crew) with systems and procedures under the one-to-one guidance of a skilled instructor. After the student 31 has completed the FTD training component 18, the student 31 begins a final stage of training, which involves training on a full-flight simulator (FFS) 20 under the instruction of a highly skilled instructor, again on a one-to-one basis. As is understood by those skilled in the art, the entire process requires a great deal of time and significant involvement of highly skilled instructors. As is also understood in the art, the process is hampered by the fact that the FTD component 18 and the FFS component 20 are expensive equipment that cannot be concurrently shared.

FIG. 1b is a schematic diagram of a training method in accordance with the invention, as applied to flight crew training. As shown in FIG. 1b, the duration of the classroom component 12, FTD component 18, and the FFS component 20 of the prior art method have been respectively reduced. In accordance with the invention, a classroom component 22 is used to introduce the students to systems and courseware modules used in accordance with the invention for a self-paced training component 24 that uses integrated system and procedure courseware on full or partial simulation for system and procedure training. The self-paced training component 24 incorporates elements from the prior art components shown in FIG. 1a as accepted by the regulatory bodies and the companies that invest in this type of training.

The self-paced training component 24 may be performed at a training center or a remote location. Rigorous authentication procedures embedded in the system prevent unauthorized personnel from accessing the self-paced training component 24 to ensure that only qualified, registered students are trained. Since the self-paced training component 24 runs over full scope simulation using interactive graphic representations of parts of the complex system, the student only has access to controls of the complex system under study, but benefits from all of the advantages of a fully integrated full scope simulation. For example, the effects of electrical power of an aircraft can be demonstrated while studying the aircraft hydraulic system, or vice versa.

Another advantage of separating simulation from the user interface is the use of multi-threading and/or multi-processing. To obtain a stable and consistent simulation, the full-scope simulation software needs to be executed at a constant iteration rate. In the desktop application, by separating the simulation software from the user interface, the complex system simulation can execute at high priority while the graphical displays around which the courseware is built execute at normal priority. In the remote application, the graphics are executed on the client side while the simulation runs on a server. When the computing platform becomes overloaded with requirements to update complex graphical representations of parts of the complex system and/or a plurality of applications are running concurrently, only the user interface process is permitted to degrade in performance, while the full-scope simulation process is optimized. In addition, the same simulation software can be used for both maintenance training and operator training. The training method is preferably geared to issue one or more qualifications sanctioned by governing authorities in the respective countries in which the courses are offered.

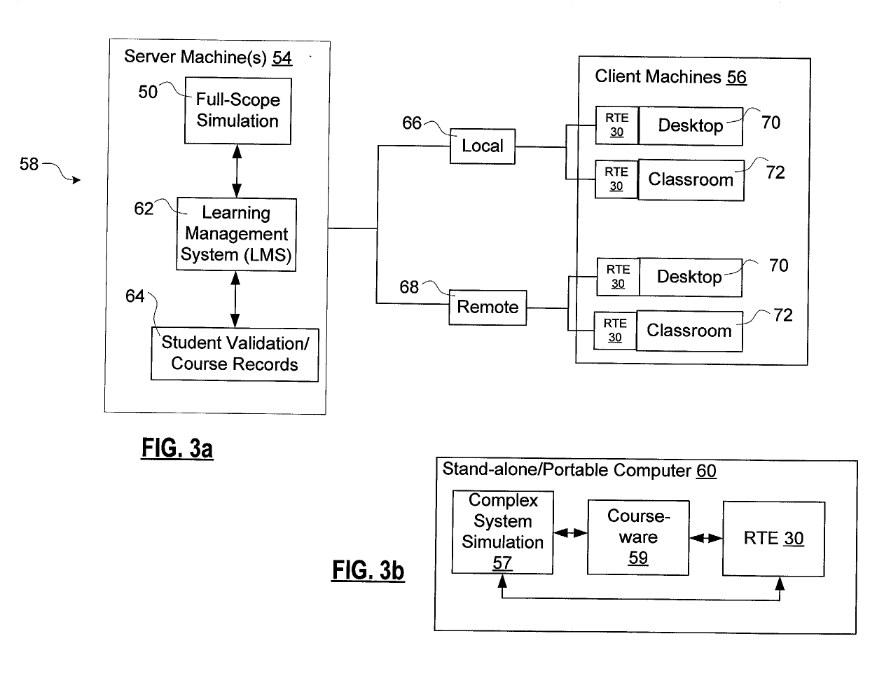

FIG. 2 is a schematic diagram of the self-paced training component 24 in accordance with the invention. A student 31 operates a computing system with a run time engine (RTE) 30, as will be explained below with reference to FIGS. 3, 5 and 6. The RTE 30 executes courseware modules that are displayed in conjunction with one or more interactive graphical representations of portions of the simulated complex system. The student 31 interacts with the courseware in order to learn integrated systems and procedures. The interaction generates inputs 32, which are passed to a validation filter function 36 that selectively filters the student inputs 32, as will be described below in more detail. While operating the self-paced training component 24, the student 31 may select one of a plurality of training modes using a training mode selector 34, for example, a menu on a courseware interface.

The training modes 35 include, for example, a Guided Practice training mode, in which the courseware guides the student 31 through predetermined steps with the guidance of text and/or audio, and permits the student 31 to interact with the courseware to generate the inputs 32. The Guided Practice training mode requires that the student 31 follow exactly each step of the integrated procedure being taught, and the validation filter function 36 blocks any wrong inputs 32 and sends a remediation message to the student 31. Should the input be valid, the input is passed onto the full-scope simulation 50, and to the interactive graphics and the training continues. Alternatively, the Practice training mode requires that the student 31 perform exactly each step of the procedure but without the guidance of text or audio. Should the validation filter function 36 intercept a wrong input, a remediation message is displayed by the RTE 30 to guide the student 31. The Practice training mode will reinforce the learning process by requiring the student 31 to develop a mental model of the process, in a manner well known in the art. Once the student 31 acquires sufficient confidence in his understanding of the systems and procedures, the student 31 can proceed with the Evaluation training mode. The Evaluation training mode is identical to the Practice training mode (no guidance with remediation), except that it collects all student inputs during the execution of the course. All results are output to a learning management system (LMS) (FIG. 3a), which compares the results against a threshold that determines if the student 31 successfully completed the course. The parameters governing the training modes are embedded in the courseware that is created by an instructor 38, such as a complex system operator instructor, or a maintenance instructor 40. The instructor uses an authoring tool application programming interface (API) 44 to create courseware 46. The authoring tool API 44 abstracts simulation variables to permit the instructor to quickly and easily create courseware modules by specifying simulation conditions using simulation control data 42 to condition the simulation to accord with desired conditions for the courseware. The simulation control data 42 can be input by the instructor without knowledge of the structure or functioning of the full-scope simulation 50. Consequently, the instructor can arrange fuel load, operating conditions, complex system conditions, and even introduce equipment malfunctions or the like, in order to enhance integrated system and procedure training courseware.

After the inputs 32 are selectively filtered by the validation filter function 36, the inputs are passed over a link 48 to the real-time, full-scope simulation 50. The real-time, full-scope simulation 50 functions in a manner well known in the art to fully simulate all of the integrated functions and conditions of a particular complex system, so that the full-scope simulation 50 behaves in all respects virtually identically to the real complex system under any given condition. Consequently, the student 31 benefits from learning integrated systems and integrated procedures by operating virtual components that effect the condition of the simulation. The condition of the simulation is, in turn, reflected to the student 31 by real-time dynamic changes in the interactive graphical representations of the parts of the simulated complex system being displayed by the courseware. The simulation 50 therefore generates outputs 52 which are selectively, based on various optimization techniques, used by the system to update the graphical displays.

FIG. 3a is a simplified block diagram of an overview of an apparatus 58 in accordance with the invention. The apparatus 58 is a client/server architecture in which a server component includes one or more server machines 54 and one or more client machines 56. The server machines 54 support the full-scope simulation 50, a learning management system 62, and student validation and course records 64. In this embodiment, the LMS 62 controls access to the courseware and maintains student records. The LMS 62 provides an interface to enable and control local and/or remote access by desktop and/or laptop computer 70, and classroom display devices 72. The desktop computer 70, classroom and display devices 72 may access the LMS 62 through a local connection 66, such as a direct connection or a local area network (LAN), Intranet, or a remote connection 68, such as a wide area network (WAN), a metropolitan area network (MAN), or an open network such as the Internet. Each of the client machines 56 includes the run time engine (RTE) 30, as described above with reference to FIG. 2, that exchanges data between the interactive graphics used to display the simulation condition and the full-scope simulation 50. The RTE 30 also transfers data generated by the student's interaction with the client machine 56 to the full-scope simulation 50.

FIG. 3b schematically illustrates another embodiment of an apparatus in accordance with the invention. In this embodiment, a stand-alone computing machine supports self-paced courseware on complex system simulation 57, which may host full-scope simulation, or a partial simulation that integrates systems required for integrated procedure training enabled by the courseware 59. The RTE 30 functions as described above with reference to FIG. 2 to exchange data between the complex system simulation 57 and the interactive graphics used to display the courseware 59 and simulated parts of the complex system. As will be understood by those skilled in the art, many other hardware configurations can be used to deliver integrated procedure training in accordance with the invention.

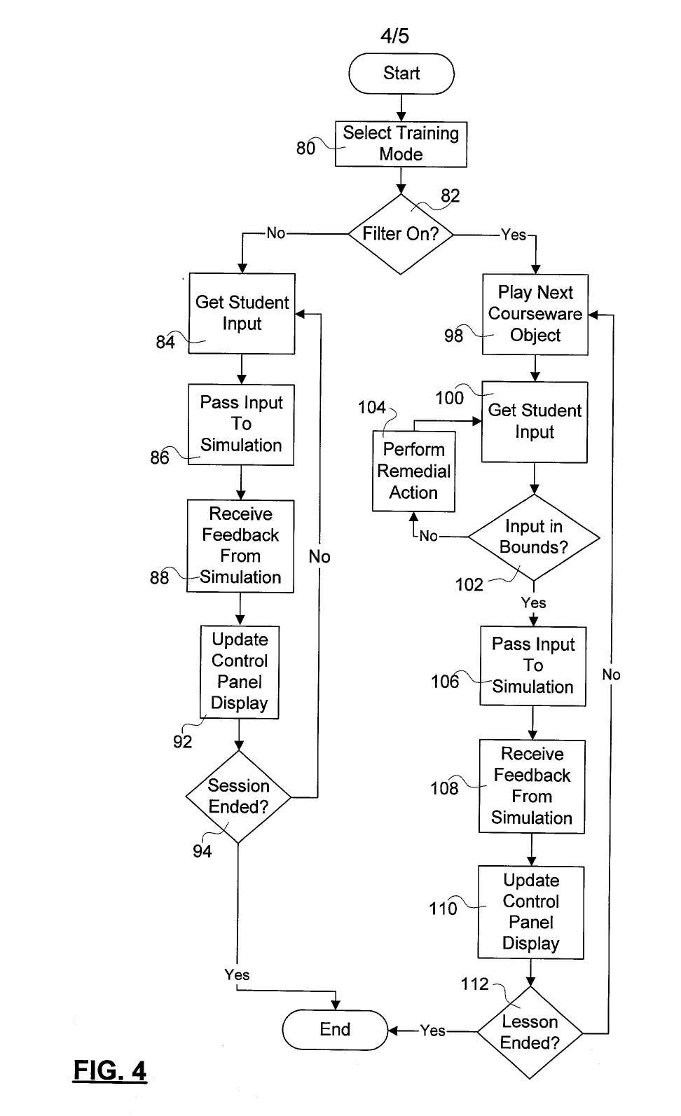

FIG. 4 is a flow chart that details the interaction of a student operating the RTE 30 with the validation filter function 36 when the RTE 30 executes the courseware 46 (FIG. 2). The process begins when the student 31 selects a lesson and/or a training mode (step 80) using the mode selector 34 shown in FIG. 2. The mode selector may be controlled by the learning management system 62 (FIG. 3) so that the student 31 may only select a training mode depending on the student's skill level, which is documented by the learning management system 62. If the student 31 selects the guided practice, practice or evaluation modes of training, the validation filter function 36 is turned on. If the student 31 is advanced enough to be enabled to select the free-play mode, the filter function 36 is turned off and inputs 32 are passed directly to the full-scope simulation 50.

If it is determined in step 82 that the filter is off, the student 31 is in free-play mode and inputs 32 are passed directly to the full-scope simulation 50. Consequently, the RTE 30 receives a student input (step 84) and passes the input (step 86) to the full-scope simulation 50. The RTE 30 then receives feedback from the full-scope simulation 50 and the graphics are updated automatically (step 88). If the session has not ended, the RTE 30 waits for a subsequent input from the student 31 by returning to step 84, and the full-scope simulation keeps computing and generating outputs until the process ends (step 94).

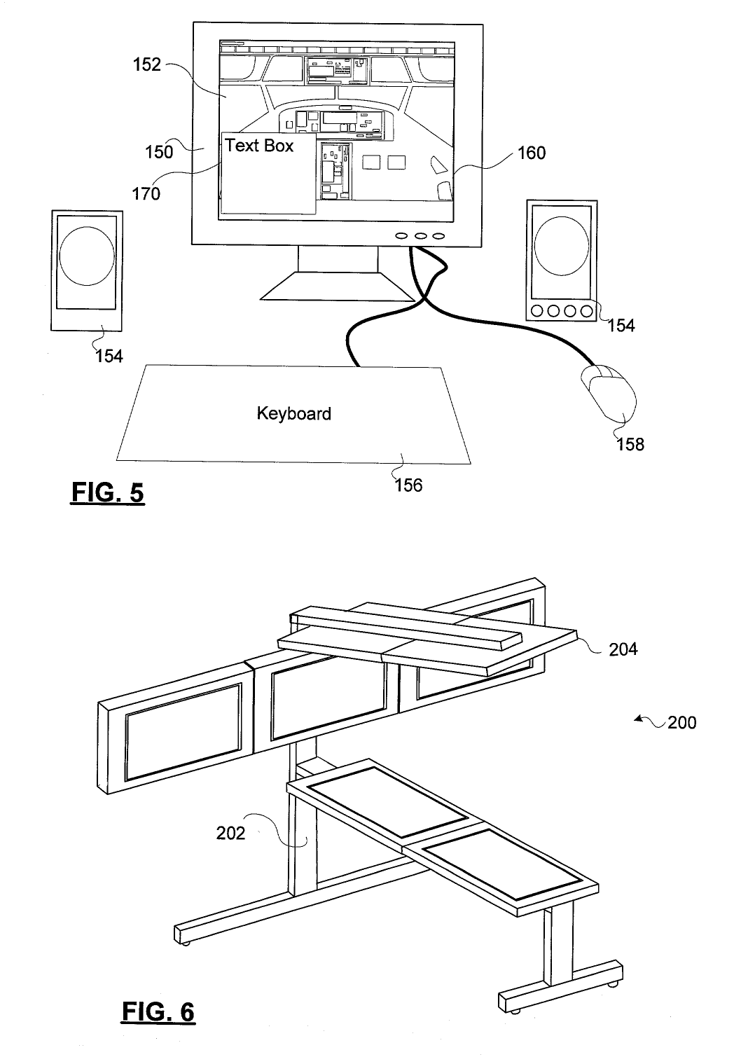

If it was determined in step 82 that the validation filter function 36 is on, the RTE 30 proceeds to play a next courseware object (step 98). Playing a courseware object may be effected using a number of different media as will be explained below with reference to FIG. 5. The RTE 30 then gets the student input 32 (step 100) and the validation filter function 36 determines whether the input is represents an action permitted by the instructor who created with courseware modules using the authoring tool API 44, as explained with reference to FIG. 2. If the input does not represent a permitted action, the RTE 30 prompts the student 31 to perform a remedial action (step 104) and awaits a new student input in step 100. This loop is repeated until the student 31 learns the correct procedure and generates the correct input 32. When the input is determined to be within the pre-specified bounds (step 102), the input is passed to the simulation (step 106). The RTE 30 then receives feedback from the simulation (step 108) and updates the interactive graphics representing part of the simulated complex system, which is a control panel in this example (step 110). The RTE 30 executes the lesson until it is completed (step 112). If the lesson has ended, the process ends. Otherwise, the RTE 30 returns to step 98 and the loop through steps 98-112 is reiterated.

FIG. 5 is a schematic diagram of one example of a desktop computer system that may be used by a student taking the self-paced training using integrated procedure courseware over a full-scope simulation 50 in accordance with the invention. In this example, one or two computer monitors display interactive representations 152 of selected parts of the simulated complex system (in this example, an aircraft cockpit) . Panning, zooming, scrolling and other display functions associated with photo realistic interactive graphics may be controlled by the courseware and/or by the student 31, depending on the training mode selected, as well as other factors well understood in the art. In addition to the computer monitor(s) 150, the computer system used by the student 31 typically includes speakers 154, a keyboard 156, and a pointing device 158, such as a computer mouse, a joystick, a track ball, a touch-sensitive pad, or any other user input device. Alternatively, the input device may be a touch-sensitive transparent input element 160 that overlays the display area of the computer monitor 150. As noted above, the self-paced training component 24 in accordance with the invention uses self-paced courseware 46 that guides students through integrated system and procedure training. The interface provides control functions that enable the student 31 to select a training mode in which the courseware is presented. For example, the courseware commentary may be presented as text in a text box 170 overlaying the interactive graphics display, or may be presented in audible format using speakers 154, or a combination of both.

The learning experience can be significantly enhanced using a three-dimensional training station 200 shown in FIG. 6. The three-dimensional training station 200, which is described in Applicant's co-pending patent application filed concurrently herewith, the specification of which is incorporated herein by reference, includes a support frame 202 that supports a plurality of display surfaces 204, which may be computer monitors or backlit projection screens arranged in a configuration that permits a display of the instrumentation and controls to be displayed using interactive graphical representations that are arranged in space in a way that substantially corresponds a three-dimensional location of the control panel's layout of the real complex system. This implementation of a display device for the self-paced training component 24 is particularly advantageous in that it permits the student 31 to learn (obtain knowledge), practice and obtain skills to perform integrated procedures (including muscle memory) that must be learned to operate and maintain the simulated complex system in a matter that is critical to the performance of the system, the safety of the system and those around it and the productive life of the system.

As will be understood by those skilled in the art, the embodiments of the invention described above represent only one of many ways in which a method of training integrated procedures using self-paced training courseware can be implemented. The embodiments of the invention are therefore intended to be exemplary only and the scope of the invention is intended to be limited solely by the scope of the appended claims.

I/we claim:

1. A method for integrated procedure training using a self-paced simulation-based integrated procedure trainer, comprising steps of:
providing self-paced courseware adapted to permit a student to learn systems, integrated procedures and skills related to a rating that the student desires to obtain;
providing a user interface that displays interactive graphical representations of portions of a simulated complex system with which the student interacts in order to learn the systems and integrated procedures;
providing means for accepting inputs from the student as the student interacts with the interface; and
providing a link between the user interface and the simulation to pass the inputs a full-scope simulation of the complex system and to provide feedback of a condition of the full-scope simulation to the student by dynamically updating the interactive graphical representations displayed by the user interface.

2. The method as claimed in claim 1 wherein the step of providing self-paced courseware comprises a step of providing a courseware authoring tool adapted to permit a course instructor to create courseware modules that conform to a standard dictated by an authority that sanctions the rating and that is compatible with the full-scope simulation.

3. A method as claimed in claim 2 further comprising a step of creating courseware for training operators of the complex system.

4. A method as claimed in claim 2 further comprising a step of creating courseware for training maintenance personnel for the complex system.

5. A method as claimed in claim 2 wherein the step of providing means for accepting inputs from the student further comprises a step of providing a validation filter adapted to examine the inputs from the student to determine whether the respective inputs are within predetermined bounds.

6. A method as claimed in claim 5 further comprising a step of providing an interface in the courseware authoring tool to permit the course instructor to input parameters to set the predetermined bounds used by the validation filter to examine the inputs from the student.

7. A method as claimed in claim 1 further comprising a step of providing a menu associated with the interface to permit the student to select one of several training modes.

8. A method as claimed in claim 7 wherein the step of providing means for accepting inputs from the student further comprises a step of providing a validation filter adapted to examine the inputs from the student to determine whether the respective inputs are within predetermined bounds.

9. A method as claimed in claim 8 further comprising a step of bypassing the validation filter, if the student selects a free-play mode.

10. A method as claimed in claim 1 wherein the step of providing interactive graphical representations further comprises a step of providing a three-dimensional display surface on which the graphical representations are displayed.

11. A method as claimed in claim 1 wherein the step of providing means for accepting inputs from the student further comprises a step of providing a touch-sensitive element overlaying a display surface on which the graphical representations are displayed, to permit the student to interact directly with controls represented by the graphical representations.

12. A method of training operators and maintenance personnel for complex systems, comprising steps of:
providing a classroom training component of an accepted complex system training course for the operator and maintenance personnel;
providing self-paced courseware on a full-scope simulation adapted to permit the operator and maintenance personnel to learn systems and integrated procedures related to the accepted complex system training course, and an interface for displaying interactive graphical representations of interfaces representing portions of the simulated complex system that the operator and maintenance personnel interact with in order to learn the systems and integrated procedures; and
providing a full-function, full-scope simulator training component of the accepted complex system training course for the operator and maintenance personnel.

13. A method as claimed in claim 12 wherein the step of providing an integrated procedure training component comprises a step of using certified instructors to develop the courseware using a courseware authoring tool.

14. Apparatus for providing integrated system and integrated procedure training, comprising:
a computer system programmed with self-paced courseware programs adapted to permit a student to interact directly with a full-scope complex system simulation and to learn integrated systems and integrated procedures related to an operator or maintenance rating that the student desires to obtain; and
a link between the computer system and the full-scope complex system simulation to permit a condition of the simulation to be changed in response to inputs to the computer system by the student, and to further permit the condition to be communicated to the student through dynamic updates to graphical representations of parts of the complex system displayed in conjunction with the courseware.

15. Apparatus as claimed in claim 14 further comprising:
at least one display monitor connected to the computer system, for displaying the interactive graphical representations of the parts of the aircraft displayed in conjunction with the courseware; and
means connected to the computer system for accepting from the student inputs associated with the courseware.

16. Apparatus as claimed in claim 14 further comprising means for storing an identity of the student and further comprising means for authenticating the student as an authorized student registered to use the courseware.

17. Apparatus as claimed in claim 14 further comprising means for storing records for documenting a progress of the student with respect to learning the systems and procedures related to the type rating that the student desires to obtain.

18. Apparatus as claimed in claim 14 further comprising a learning management system adapted to store an identity of the student and determine whether the student is authorized to use the courseware, and further adapted to store records documenting a progress of the student with respect to learning the systems and procedures related to the type rating that the student desires to obtain.

19. Apparatus as claimed in claim 15 wherein the means connected to the computer system for accepting the inputs comprises a touch-sensitive element overlaying a display screen of at least one monitor.

20. Apparatus as claimed in claim 15 wherein the means connected to the computer system for accepting the inputs comprises a pointing device.

21. Apparatus as claimed in claim 14 further comprising an application programming interface adapted to permit an instructor to create the courseware.

22. Apparatus as claimed in claim 21 wherein the application programming interface further permits the input of simulation control data used to condition the complex system simulation as required to accord with the courseware.

23. Apparatus as claimed in claim 14 further comprising a validation filter associated with the link between the computer system and a full-scope simulation, the validation filter being adapted to monitor the inputs and pass only those inputs that are within predefined bounds to the simulation.

24. Apparatus as claimed in claim 23 further comprising a menu adapted to permit the student to select any one of a plurality of modes.

25. Apparatus as claimed in claim 24 further comprising means for bypassing the validation filter when the student selects a free-play mode.

26. Apparatus as claimed in claim 14 further comprising a network interface to permit the student to access the computer system from a remote location.

27. Computer-readable medium for storing computer-executable program instructions, comprising:
self-paced courseware program instructions adapted to permit a student to learn systems and integrated procedures related to an operator or maintenance rating that the student desires to obtain; and
program instructions for establishing and maintaining a link between a computer system that executes the self-paced courseware programs and full-scope complex system simulation, to permit a state or condition of the full-scope complex system simulation to be changed in response to inputs by the student, and to further permit the state or condition to be communicated to the student through dynamic updates to graphical representations of parts of the complex system displayed on a display device in conjunction with the courseware.

28. Computer-readable medium as claimed in claim 27 further comprising program instructions for storing an identity of the student and further comprising program instructions for authenticating the student as an authorized student registered to use the courseware.

29. Computer-readable medium as claimed in claim 27 further comprising program instructions for evaluating a learning progress of the student and storing records for documenting the learning progress of the student with respect to learning the systems and procedures related to the rating that the student desires to obtain.

30. Computer-readable medium as claimed in claim 27 further comprising program instructions for providing an application programming interface adapted to permit an instructor to create the courseware program instructions.

31. Computer-readable medium as claimed in claim 30 wherein the program instructions for providing an application programming interface are further adapted to permit the input of simulation control data used to condition the complex system simulation as required to accord with the courseware.

32. Computer-readable medium as claimed in claim 27 further comprising program instructions for performing a validation filter function associated with the link between the computer system and the real-time complex system simulation, the validation filter function being adapted to monitor the inputs and pass to the complex system simulation only those inputs that are within predefined bounds.

33. Computer-readable medium as claimed in claim 32 further comprising program instructions for providing a menu adapted to permit the student to select any one of a plurality of training modes.

34. Computer readable medium as claimed in claim 33 further comprising program instructions for bypassing the validation filter when the student selects a free-play mode.

35. Apparatus as claimed in claim 27 further comprising program instructions for providing a remote access interface adapted to permit the student to access the courseware program from a remote location.
